(19) United States
(12) Patent Application Publication
(10) Pub. No.: US 2008/0007400 A1
(43) Pub. Date: Jan. 10, 2008

(54) Image projection system

(76) Inventor: Terry Murphy, Georgetown, KY (US)

Correspondence Address: STOCKWELL & SMEDLEY, PSC, 861 CORPORATE DRIVE, SUITE 200, LEXINGTON, KY, 40503, US

(21) Appl. No.: 11/804,227

(22) Filed: May 17, 2007

Related U.S. Application Data
(60) Provisional application No. 60/819,327, filed on Jul. 7, 2006.

(51) Int. Cl. G08B 5/00; F21S 8/00; G08B 21/00

(52) U.S. Cl. 340/540; 116/209; 340/332; 362/153; 362/227

(57) ABSTRACT

A laser projector and software are disclosed. The software controls the laser projector for factory and warehouse floor-room marking and signage.

### CROSS-REFERENCE TO RELATED APPLICATIONS

This application claims priority to U.S. Provisional Application No. 60/819,327, which was filed on Jul. 7, 2006.

### FIELD OF THE INVENTION

This invention relates generally to projection lasers.

### BACKGROUND OF THE INVENTION

This invention was conceived to eliminate the need to continually paint lines on the floor in factory or warehouse environments. Often equipment must be shut down and processes halted to refresh the safety lines, resulting in lost revenue. Consequently, a means of maintaining the visibility of safety lines without having to shut down factory equipment or warehouse processes is desired. As shown in FIG. 1A, the prior art floor system includes painted lines 121 and arrows 123 having worn areas 125. Consequently, a means of using an image projection system to manage a factory or warehouse floor is desired.

### SUMMARY OF THE INVENTION

It is the object of this invention to maintain the visibility of cautionary and directional lines on factory and warehouse floors, and allow these lines to be instantaneously removed and redisplayed elsewhere when circumstances require. It is another object of this invention to utilize animation graphics to make conspicuous to persons all safety and assignment directions. This invention was also conceived for the purpose of drawing greater attention to signage on factory and warehouse floors. These and other objects and advantages of the invention will become readily apparent as the following description is read in conjunction with the accompanying drawings.

### BRIEF DESCRIPTION OF THE DRAWINGS

FIG. 1A illustrates a prior art warehouse floor environment.

FIG. 1B is an overview of an exemplary embodiment of the present invention;

FIGS. 2-7 show the embodiment of FIG. 1 in various configurations;

FIGS. 8-10 are views of a projector used within the embodiments shown in FIGS. 1-7; and

FIGS. 11-16 are screen captures of software used within the within the embodiments shown in FIGS. 1-7.

### DETAILED DESCRIPTION OF THE PREFERRED EMBODIMENTS

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

In today's factory and warehouse environments, floor safety and organization are regulated more tightly than ever. Plant management recognizes that the greater organized a plant is, the more efficient it will operate, and the safer it will be for its operators and guests.

Accordingly, one function of the present invention is to provide an improved type of factory or warehouse floor labeling. The present invention replaces paint, tape, and other floor-labeling media with projected laser light. Doing so eliminates the negative impact of direct, wear-and-tear, dirt, and tire marks that require periodic maintenance on the paint-and-tape method. Laser projections do not require re-marking to restore visibility.

Also, because of the flexibility of the present invention, changing or moving a floor-marking image requires little effort. All changes can be implemented within easy-to-use computer software. Additionally, by incorporating the animation features of the present invention, images are not static and thus do not become “part of the woodwork”. This in turn increases safety awareness which can decrease accidents and injuries.

Factory or warehouse floor organization is governed by regulatory agencies, state and local codes, and by companies risk management policies and procedures, and carried out pursuant to plant policy through programs like 5-S and Six Sigma. To be compliant with these, factories and warehouses are required to outline on the floor every machine with a clearly visible marking, and indicate with a label what that machine is. Additionally every walkway and high incident area must be labeled as well. A factory or warehouse will traditionally label and outline its equipment using a two inch yellow strip of paint. Although this is common practice, it is not a requirement of some regulatory agencies. The consistent regulatory agency requirement is that the lines are clearly visible.

Most regulatory agencies have stringent standards for clear visibility of marking-lines. Specifically, if during an inspection a regulatory agency finds some minor wearing down in the center of the marking-line, this can be considered a violation. This is true even if the overall line is still clearly visible. Because of the pressure to appease regulatory agencies and to operate without fear of violation and fines, factories and warehouses must continuously shut down their equipment so that the lines can be refreshed and repainted to ensure visibility. This downtime results in loss of significant amount of income for the factory or warehouse and disrupts a steady efficient pattern of work for the employees.

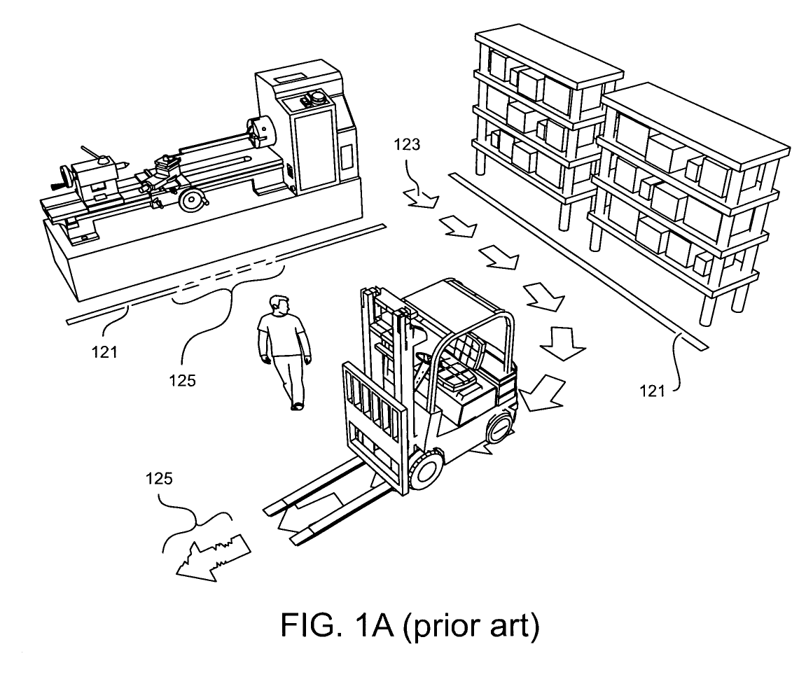

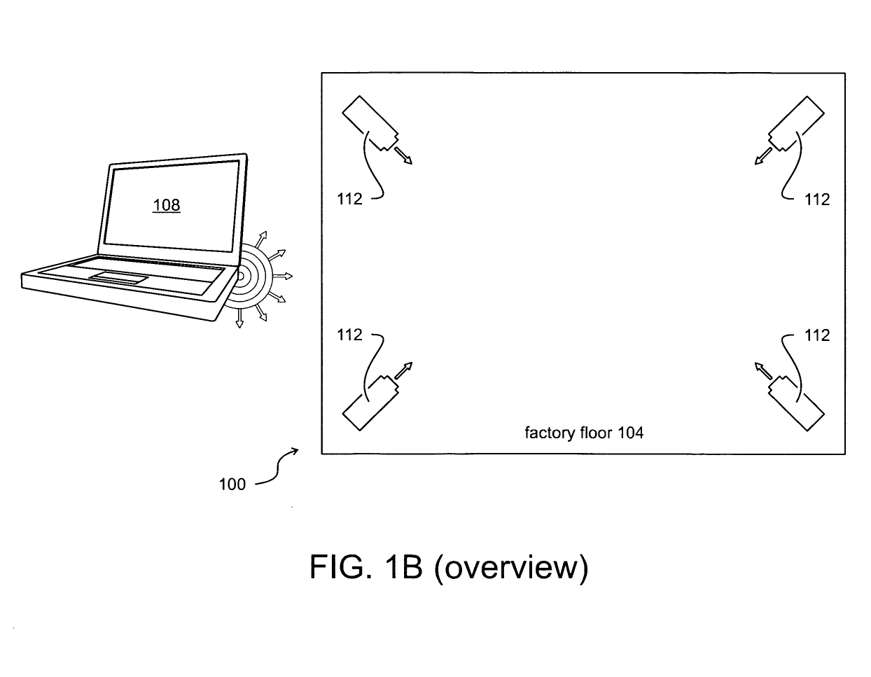

The present invention eliminates the necessity of continually stopping and painting these lines. As shown in FIG. 1B, a factory/warehouse floor 104 is governed by the computer and projector network 100 of the present invention. The network 100 includes a dedicated server or servers 108 which is connected to a series of projectors 112.

Each projector 112 and the dedicated server 108 have their own internal IP address (Internet Protocol). This is not the same as an external or universal IP address, but instead is an internal-only IP address that is available only within the network structure internal to the factory or warehouse environment. One advantage of such a network topology is that the entire suite of IP utilities is available to communicate with a projector. For example, the dedicated server 108 can periodically poll the status of a particular projector 112 by use of the “ping” command which is one of the suite of commands available within the IP protocol. Additionally, each projector 112 has a dedicated memory 808 upon which various types of image data and instructions can be stored.

Within the network 100 of the present invention, the dedicated server 108 cannot be used for any other purpose. It must be devoted entirely to servicing the network 100. However, as user changes and requirements occur, the server 108 provides a “back door” entry point for users of the network 100 to introduce changes, updates, and new data. This includes remotely adding or removing projectors 112.

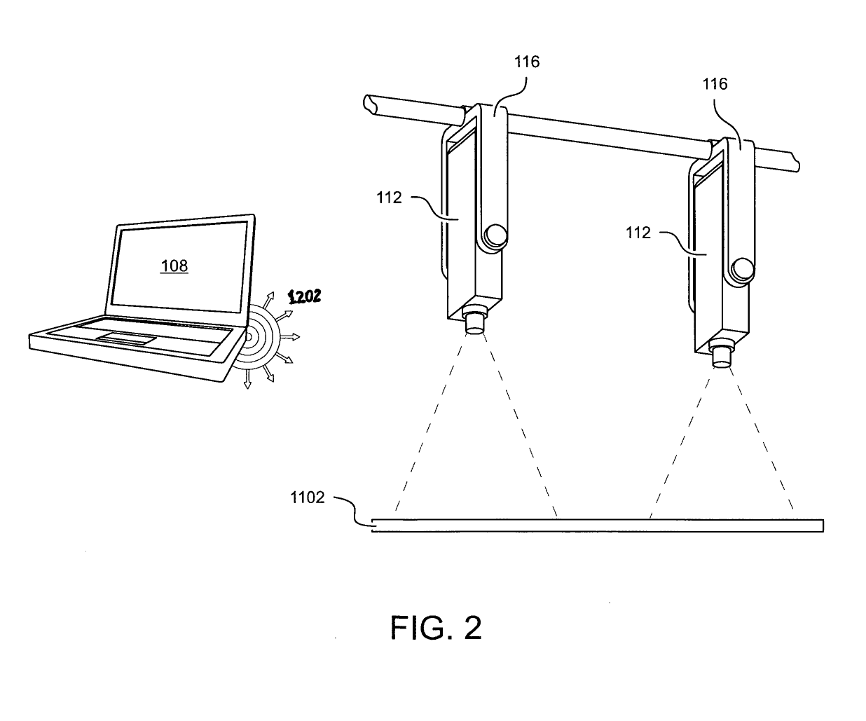

FIG. 2 shows how a series of laser projectors 112 could be hung overhead using their handles 116, for the projection of patterns 1102 onto a floor. Because the projection would be straight down, there is less problem with obstructing the laser by interfering with its beam. Each projector 112 has an optimal use of creating a 50 foot line pattern 1102 with precision.

FIG. 2 shows that by placing the projectors 112 in series, the lasers can work together to create a significantly longer line 1102. The length of the line is proportional to the height of the projector 112.

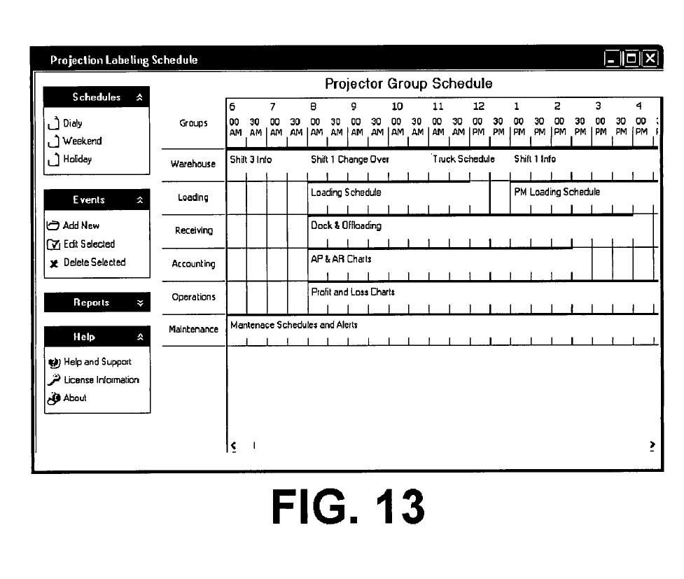

FIG. 2 also shows how the dedicated server 108 controls the input and output for the projectors 112 via a wireless network connection 1202. This dedicated server 108 can control up to 256 of the projectors 112, however optimal conditions are using a single computer for 100 projectors. The primary reason for lessening the number of projectors 112 on a single dedicated server 108 is not for quality sake, but rather manageability. The software running on the dedicated server 108 manages each projector 112 on both an individual and group basis (FIG. 13). However because many of the projectors 112 will perform different functions, the operator may find that the manageability of the software becomes easier by decreasing the number of projectors 112 controlled by a single computer.

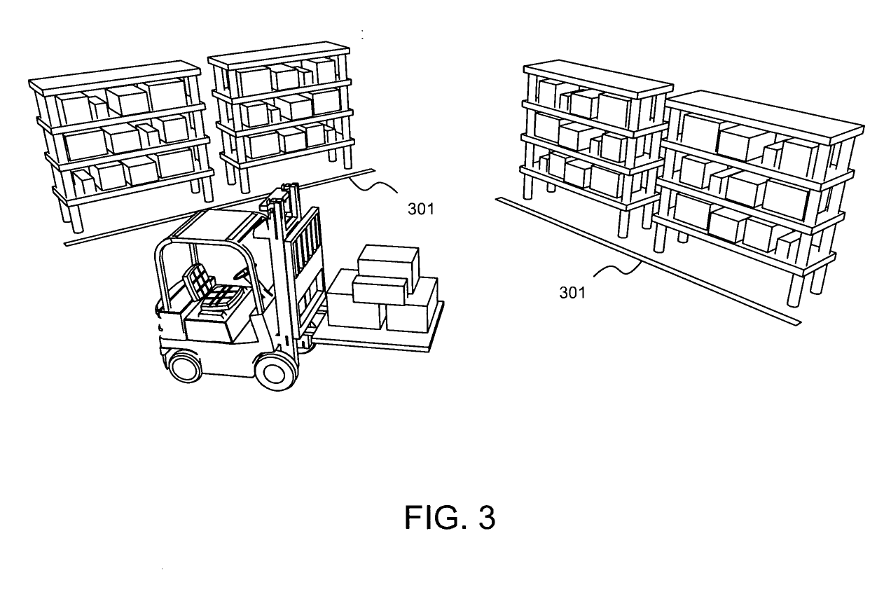

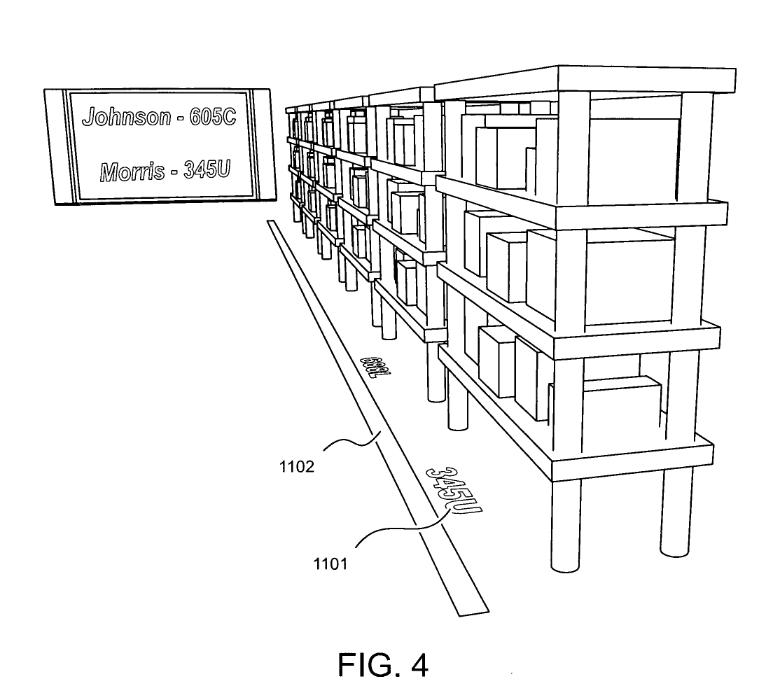

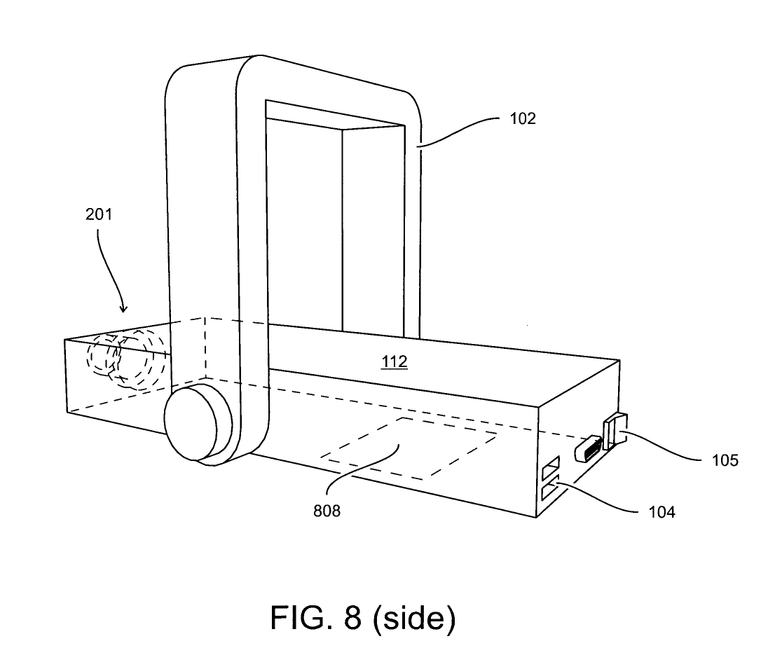

FIGS. 3 and 4 show how a projector 112 can be used to maintain a consistent pattern 301, 1102 of visible light shone upon the floor. By shining these lasers 201 ( See FIG. 8) upon the floor, the pattern 301, 1102 is constant and unfading, for the life of the projector 112. Also, the projectors 112 can be easily replaced without the need to cease operations on the factory and warehouse floor machinery, thereby resulting in a significant annual decrease of downtime for the machines.

Each projector 112 is capable of controlling four separate laser functions at any given time. Therefore, at its limit, a single dedicated server 108 controlling 256 projectors, each of which are performing 4 functions, has the dedicated server 108 controlling more than 1,000 operations at any given moment.

Each projector 112 can control four functions at any given moment, however there are limitations on those functions. Because each projector 112 is equipped with a memory card, the dedicated server 108 can give a command for three separate functions such as lines or other static, non-animated graphics. By using its memory, the projector 112 can store this command and continue to follow it until directed by the dedicated server 108 to do something else. This increases the efficiency of the network 100 by not requiring the dedicated server 108 and each projector 112 to be in constant communication. In increasing efficiency this way, the dedicated server 108 is freed up to communicate more continuously with a single projector 112 that may be displaying an animated image.

Lines for aisle walkways could be one usage of the projectors 112, because that is a well-known factory and warehouse floor requirement. However, the projectors 112 will be able to serve a number of purposes. Often in factories or warehouses, forklifts and other such machinery must be very precise in removing and placing objects for safety reasons and to comply with manufacturing processes.

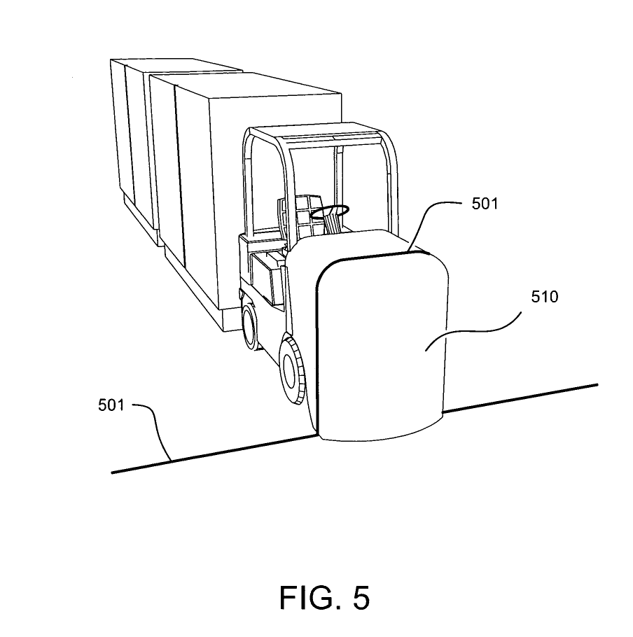

Another feature of the present invention involves forklift loads. Currently, forklift drivers carrying a large object where visibility may be impeded must operate the forklift while hanging dangerously off to one side to see if the object is where it needs to be, resulting in an unsafe condition and also resulting in undue trial and error. FIG. 5 shows using a laser to create a target 501. An operator of a mobile machine 510 uses the target image 501 projected onto the machine 510 for accuracy.

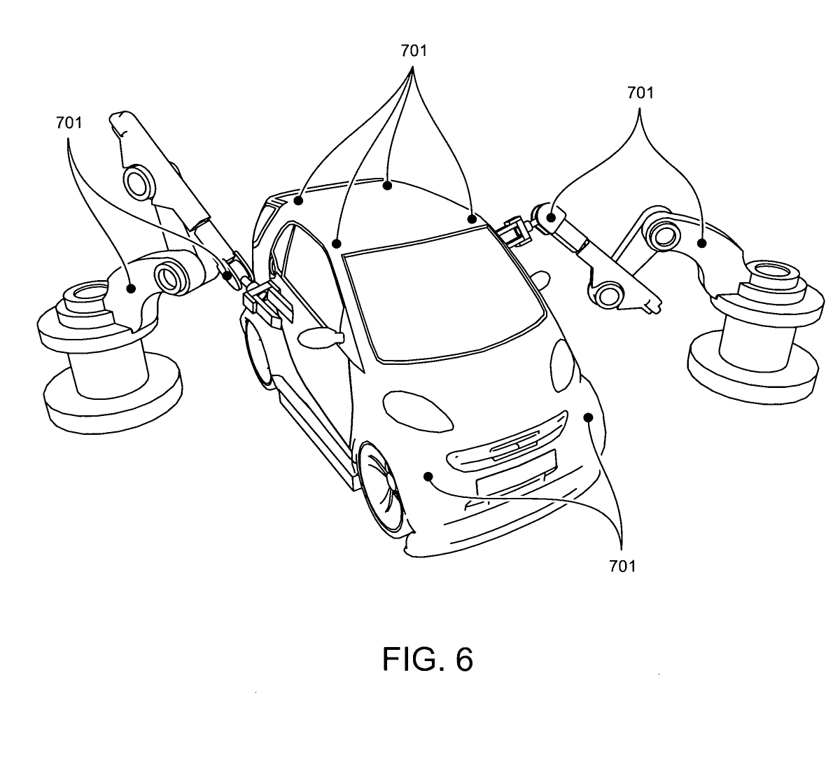

With the use of the projectors 112, targets 701 can be utilized to achieve maximum precision. For example, FIG. 6 shows that by adding targets 701 on to the thing to be moved or repaired, greater precision can be achieved.

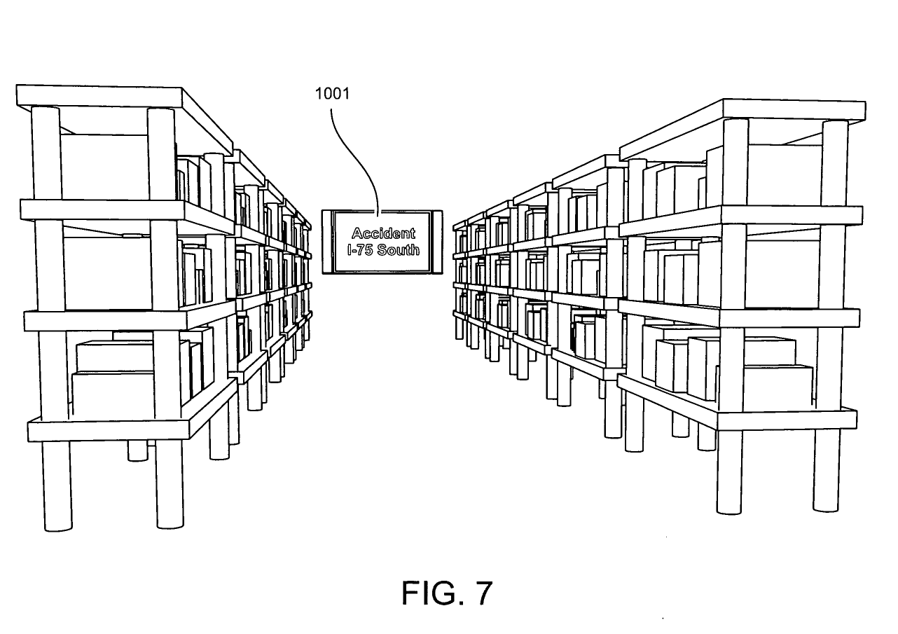

In many larger factory and warehouse floors, the factories or warehouses require that part numbers for products be clearly labeled, and sometimes use the actual floor for that purpose. Accordingly, FIGS. 6 and 7 represent different uses of the projector 112 of the present invention, including labeling part numbers on the floor 1101, labeling signage through out the floor room 1001, and a multitude of other purposes. A user of the dedicated server 108 can add any image that has been converted to laser vector format, as well as text.

The projectors 112 can also create animated graphics. The projectors 101 utilize a scanner to create images that move. Basic animations are installed on the graphic user interface of the software running on the dedicated server 108. These animations can be used for countless purposes such as, but not limited to, aid in fire or tornado situations. The projectors can work conjunctively with one another, as well as being integrated into the fire and tornado alarm systems.

Generally, whenever a fire or tornado warning is issued, an alarm is sounded accompanied by flashing lights, such as for example red. Laser projectors 112 could be used to supplement these warning devices. Through integration with the warning alarm, the lasers that line the walkways can be programmed to use animation graphics like moving arrows to direct persons to the nearest exit in the event of a fire, or to the nearest tornado-proof structure in the event of a tornado. These lasers 201 can maintain the lines for the walkways while operating the moving arrows. Because of the integration with the system, the shift to using the arrows is automatic and requires no input from the operator.

Additionally, should the EMT be called, the projectors 112 can operate as a guide telling the EMT which route to take to get to the injured person. The operator can, through the interface, note that there is an EMT emergency, then can choose the location of the injury, and the walkway lasers will use arrows starting from the primary entrance for the EMT to the destination of the injured person. This will avoid the risk in the larger factories and warehouses of the EMT getting lost and misusing valuable time.

Another use of animation is to rid the factory or warehouse floor of the problem of ignoring warning signs because they fade into the background of mundanity over time. Often warning signs such as “Stop!, Look!, Listen!” will lose their effect after a short period of time because they are no longer something new and different, so people do not notice them. By using animated graphics that can continuously change, employees will continue to notice the warning sign in high incident areas like corners.

In conjunction with the warning sign displays described above, factory or warehouseowners could install chips in the forklifts and other such machines so that as they approach a in high incident areas such as a corner, a stop-sign graphic will appear. This could be done by implanting a sensor in the wall as well as the equipment, and integrating the sensor with the projectors 112. In fact, with motion sensors of this sort, it is possible there is no need for the lasers to communicate with the dedicated server 108, because the laser is capable of taking the input and adjusting to show “Stop”. To achieve this, the “Stop” graphic uses the memory 808 of the projector 112.

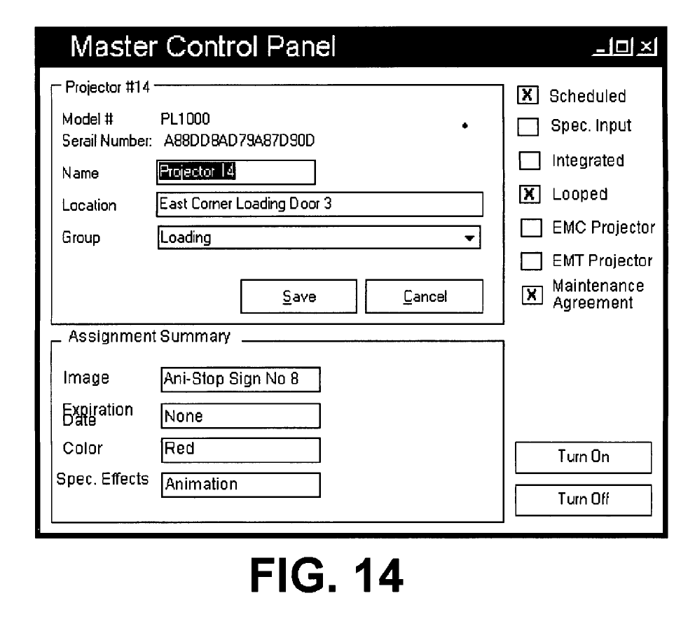

Light sensors may be used similar to the motion sensors that work through the projector 112 itself rather than the dedicated server 108. Therefore, because it is unnecessary to have the lasers 201 operating all night, it is possible to have the system shut down after the last shift for the day by using the software option in FIG. 14.

Pick and delivery systems are order fulfillment technologies used in warehousing. This name arises because warehouse workers (order pickers) are notified by either LED light diodes, a handheld scanner or a simple voice command on what to pick. In many larger factories and warehouses, where the order pickers are using mobile pallet jacks, forklifts or tuggers to pick the order for delivery, even the pick command is often not enough to ensure that the correct items are delivered. Misdeliveries sometimes occur because of a lack of communication and attention between the drivers and those at the factory or warehouse. To correct this problem, the lasers can be integrated with the pick and delivery systems that many factories and warehouses have implemented.

By integrating the laser projectors and software with pick and delivery systems, the lasers can be used to display on the delivery doors the part number as well as the name of the driver. A long string of numbers can sometimes confuse a driver. Accompanying that string with the driver's name could reduce this confusion.

The part number 1101 and driver name can be displayed either together, or as an alternating graphic. Voice recognition software that recognizes information provided by the pick system and can transform it into text. Additionally, when the driver confirms through the pick system that the delivery is successful, the laser 201 will be able to move forward to the next delivery.

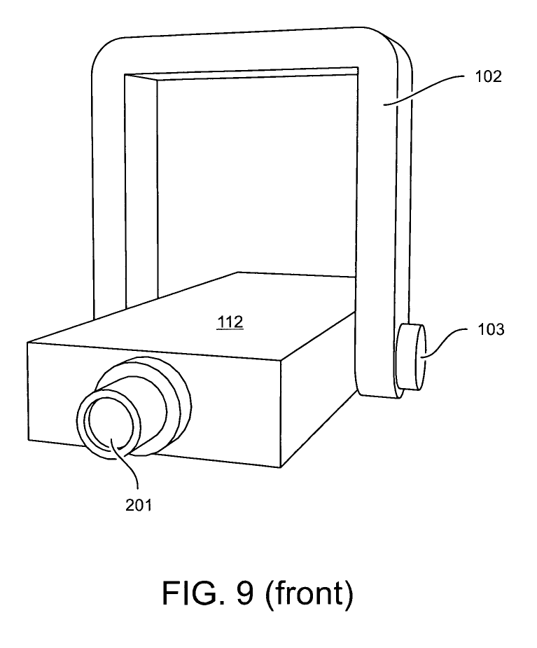

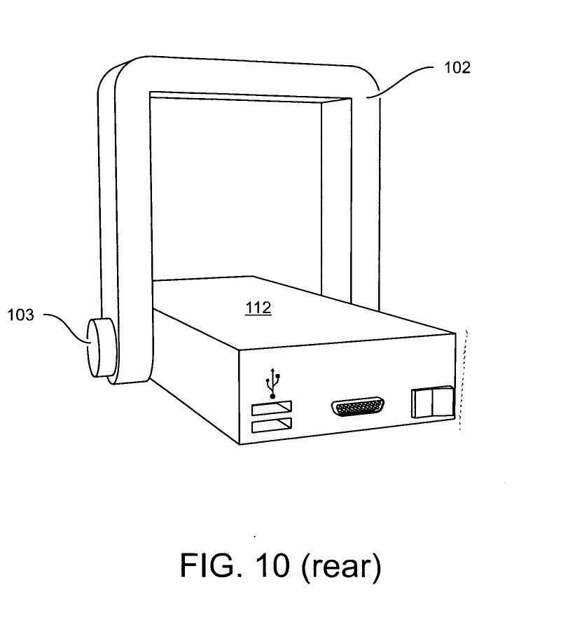

An exemplary embodiment of a projector 112 is shown in FIGS. 8-10. However, FIGS. 8-10, like all figures herein, are meant to be exemplary only, so that the present invention should not be considered as limited exclusively thereto. From FIG. 8 it is apparent that the projector 112 contains a dynamic memory 808, which allows the dedicated server 108 to deliver multiple types of data to a single projector 112, which can store each type in its memory 808. The projector 112 can operate various ways, including not shifting to the next input until the first has been picked up, or shifting to the next input once a certain amount of time before the intended pick-up occurs. Additionally, because the dedicated server 108 can simultaneously operate a large number of projectors 112, it can allocate automatically which deliveries and pick-ups should occur where.

Within the projector 112 of the present invention, the optimal color for cost efficiency, as well as visibility, is green. However, other colors such as red, blue, yellow, etc are available as well. The projector 112 can potentially work in outdoor situations where there is low ambient light also.

Use of projectors 112 from above directed at the ground level where people will be able to look directly at the laser could cause an eye safety issue. However, because the projectors 112 are calibrated and tuned to be at low power, looking directly into their lasers will not cause eye damage unless done for an extended period of time.

As stated, the projection network 100 of the present invention is operated remotely by a dedicated server 108, which uses various software modules to perform the operations necessary to convey information to a projector 112. Using the software, the operator will be able to create the graphics to be used by the projector, including images, such as lines or logos, text and animations. The format for this line art that the operator creates is bitmap and thus the operator can import any bitmap drawing for projection.

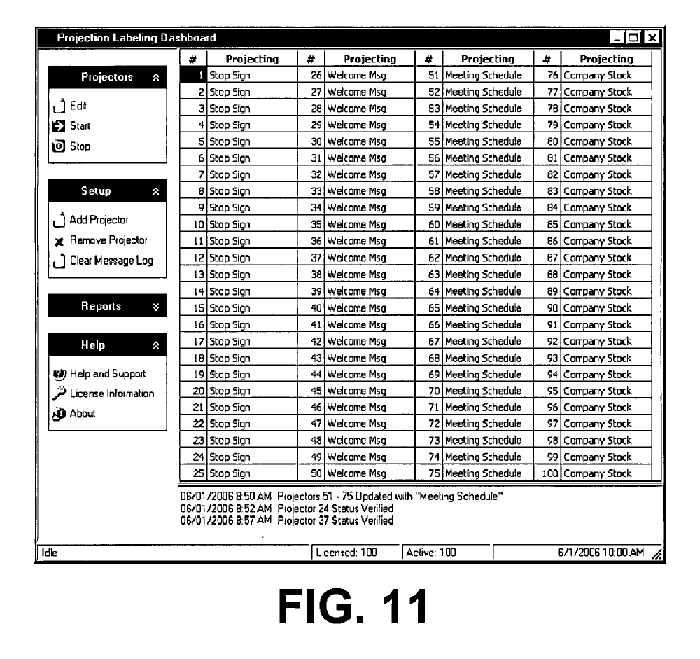

Exemplary screens of the software running on the dedicated server 108 are shown in FIGS. 11-16. It is to be noted that these figures are exemplary only, so that the present invention should not be considered as limited exclusively thereto. FIG. 11 shows the main screen a user will encounter when first using the software on the dedicated server 108. The title bar is labeled “Projection Labeling Dashboard” because this menu serves as the executive dashboard. FIG. 11 shows that the dashboard provides a convenient view of 100 projectors 112, although the present invention supports more. From FIG. 11 it is apparent that the dashboard also shows how many projectors are licensed, how many are active, and a short summary of what each projector is currently displaying.

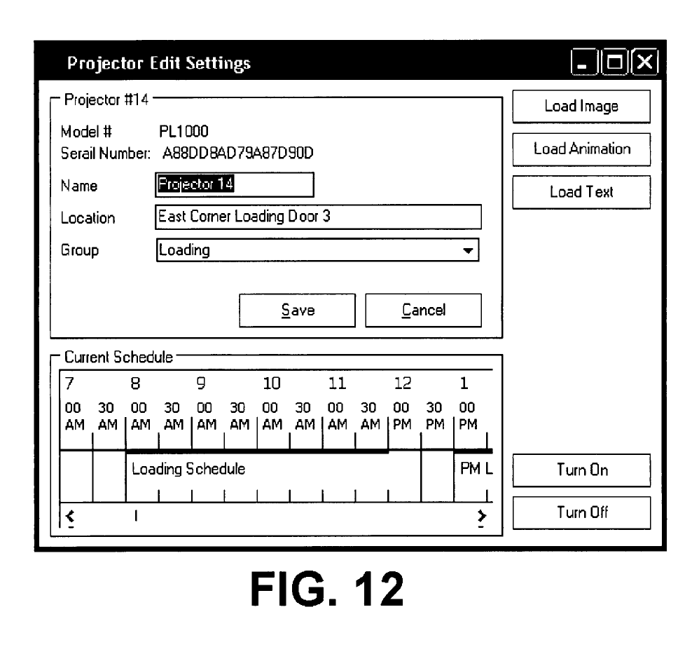

Within the dashboard of FIG. 11, if a user were to double-click on the projector numbered 14, that user would then be taken to a screen which looks like the “Projector Edit Settings” screen shown in FIG. 12. This screen shows many of the network characteristics unique to a specific individual projector. Clicking on the “Current Schedule” portion of the menu shown in FIG. 12 would take a user to the Schedule (FIG. 13), as connoted by the “Loading Schedule” portion of the image, which is not a permanent part of the menu in FIG. 12. FIG. 13 shows the projection schedule when grouping projectors together to project the same image on the same schedule.

Meanwhile, clicking on the “Turn On” portion of the menu in FIG. 12 would take a user to the Master Control Panel (FIG. 14). In the Master Control Panel (FIG. 14), the terms “Spec. input”, “Integrated”, “EMC Projector”, and “EMT Projector” are shown. The term Spec Input refers to any outside inputs that affect the projection, i.e., warehouse management systems, RFID, or pick and delivery systems. The term Integrated describes whether this projector being controlled directly from other software such as WMS Systems (Warehouse Management Systems), Pick and Delivery Systems, or RFID Controls Systems, and thus not from the software of the present invention. The EMC field, if checked, shows that a particular projector is part of the Emergency Management Communication system controlled by our software, i.e., fire, tornado warning and directions. Similarly, the term EMT field, if checked, shows that a projector used to direct medical personnel to a location in the case of an injury.

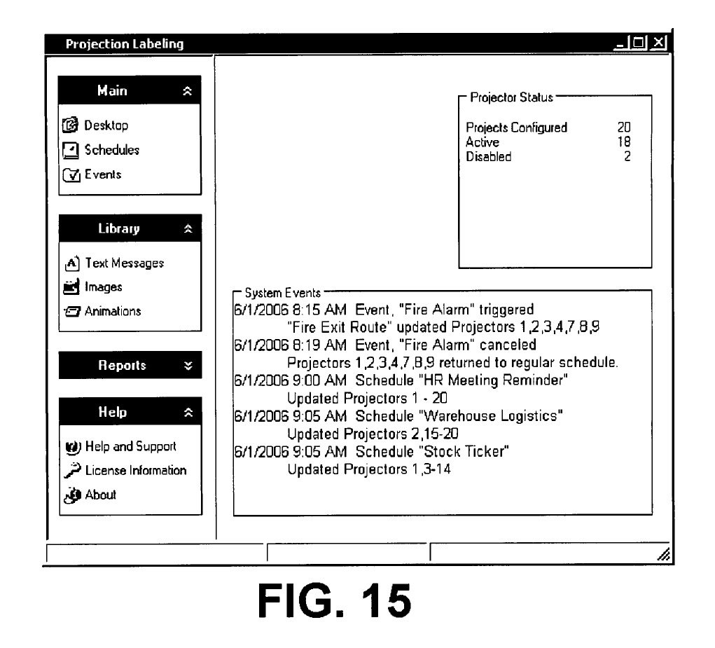

Clicking on either the “Edit” or “Clear Message Log” portions of the Dashboard (FIG. 11) would take a user to the event logger (FIG. 15).

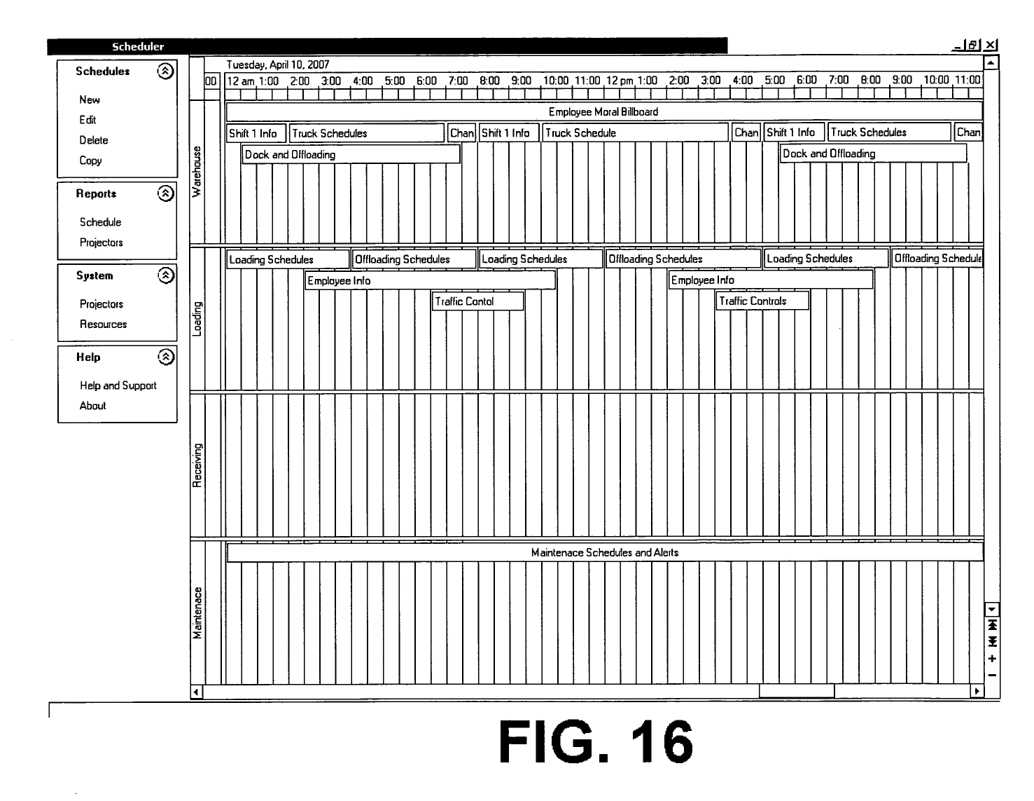

FIG. 16 shows more detail of the scheduler feature of the software. A user arrives at the FIG. 16 Scheduler by double clicking on the projector number shown in FIG. 11. FIG. 16 is for individual projectors only. The exemplary menu shown in FIG. 16 divided into four parts, including maintenance, receiving, loading, and warehouse. However, other visual arrangements are also contemplated within the spirit and scope of the invention.

Within the Scheduler shown in FIG. 16, the meaning of the term “Chan” is that during the times shown, a specific projector will show a normal image (that is channel fed, from the dedicated server 108 as opposed to being resident within the memory of the projector itself). FIG. 16 shows “Loading Schedules”, “Offloading Schedules”, “Employee Info”, and “Traffic Control”, which are exemplary identifiers to show what images appear during the specific times shown.

The software running on the dedicated server 108 is also capable of displaying the graphics in ways distinct from animation, such as by rotating, fading, morphing or other variations thereof, to manipulate the images produced by the projector. Additionally, a user can choose colors of the projections from the software interface, and assign different colors to different image parts.

Once a computer uses the software to create images and text to be displayed, the software is capable of creating laser vectors from the line art supplied to it by the operator. Using the laser vectors, the projectors will display the images created by the operator in the way described above.

One goal of the network 108 is longevity and minimizing downtime of industrial equipment and machines on the factory or warehouse floor. In furtherance of that goal, during the creation of the laser vectors, the software has been designed to automatically minimize the number of stop points. A “stop point” is the point at which the scanner changes the direction of a straight line to form the image, whether it is a word or a line.

Within previous projection systems, there would be several stop points in any given line or letter. Conversely, within the present invention, the stop points are minimized such that, for example, a single line may have only 2 stop points, rather than 5 or 6, and the letter “R” may only have 5 stop points, instead of 10 or more. By minimizing these stop points, the level of energy of the output of the projector 112 is greatly diminished, therefore it can work more efficiently, thereby extending its life of the projector 112 up to 35%.

A summary of the functionality of the software running on the dedicated server 108 is as follows:
1. create graphic images including both functional and non-functional, such as images that enhance room aesthetics
2. create alphanumeric text
3. create animations
4. set properties for displaying images (rotate, fade, morph, etc)
5. software automatically minimizes number of “stop points”
6. assign color to image parts
7. automatically create laser vectors from line art (bitmaps)
8. multiple projector control, can be managed remotely through a web portal
9. scheduling images to only occur only at specific times, and send other images at different times
10. activity log of a specific projector, for debugging and tracing errors
11. mass delete capability of stop points, advantageous when editing images
12. mass move capability
13. navigational controls presented together, not necessary to open an additional window
14. GUI (graphical user interface) designed to be “industrial” and user friendly, reduces training time
15. functionality add-ons such as Emergency Management Communication
16. “back door” access for troubleshooting, downloading updates, images, etc.
17. integrated with inputs from motion sensors, light detectors, etc
18. ability to “group” projectors for programming
19. ability to set count downs, i.e., expiration dates, etc.
20. RFID input signals
21. projector diagnostics capabilities

An additional feature of the software is the capability of deleting an image in its entirety. The software can put a “box” around whatever laser vector a user wishes to delete. Pressing the delete key will remove that entire image, rather than merely being able to delete each stop point one at a time. This deletion function is in furtherance of manageability and time efficiency, as opposed to deleting one vector point at a time.

As stated, the software is also equipped with “backdoor” access for trouble shooting, downloading updates and images from the inventor and his organization. This feature will allow greater customer service by being to assist any complications the operating is having with the software and controlling the projectors, as well just to keep the system new. The operators can hire the inventor to create graphics for the projector, so this backdoor permits an easy channel of interchange between the operator and the inventor.

It is anticipated that various changes may be made in the arrangement and operation of the system of the present invention without departing from the spirit and scope of the invention.

What is claimed is:

1. An image projection system, comprising:
a plurality of laser projectors connected to a dedicated server equipped with software for driving and managing said projectors;
wherein the projectors are mounted above ground level and project predetermined images in a variety of directions.

2. The image projection system of claim 1, wherein the predetermined images are loaded using the software.

3. The image projection system of claim 1, wherein the laser projectors further comprise memory storage.

4. The image projection system of claim 1, wherein the memory storage can hold image data and instructions.

5. The image projection system of claim 1, wherein the projectors are interconnected within a computer network.

6. The image projection system of claim 2, wherein the laser projectors include a scanning system configures to create animated graphics.

7. The image projection system of claim 1, wherein the software includes a graphical user interface.

8. The image projection system of claim 1, wherein the software further comprises a plurality of control functions.

9. The image projection system of claim 7, wherein one of the control functions comprises a text input function.

10. The image projection system of claim 7, wherein one of the control functions comprises a graphic upload function.

11. The image projection system of claim 7, wherein one of the control functions comprises an animation control function.

12. The image projection system of claim 7, wherein one of the control functions comprises a pick and delivery system input.

13. The image projection system of claim 7, wherein one of the control functions comprises an alarm system input.

14. The image projection system of claim 1, wherein each projector further comprises:
an internal-only IP address that is available only within a network structure internal to a warehouse environment

15. The image projection system of claim 1, further comprising:
a suite of Internet Protocol utilities by which the dedicated server communicates with any of the plurality of projectors.

16. The image projection system of claim 15, wherein the dedicated server periodically polls the status of a particular projector by use of the “ping” command.

17. The image projection system of claim 1, wherein the dedicated server is devoted entirely to servicing the internal projector network

18. The image projection system of claim 1, wherein the plurality of projectors are arranged in series to create a longer line than what is available by a single projector.

19. The image projection system of claim 1, wherein the dedicated server controls the input and output for the projectors via a wireless network connection.

20. The image projection system of claim 1, wherein the plurality of projectors further comprise:
a scanner applet configured to provide animated graphics.

21. The image projection system of claim 1, wherein the plurality of laser projectors are configured to communicate with warning devices.

22. The image projection system of claim 1, wherein the plurality of laser projectors operate to guide emergency personnel along a route to take to get to an injured person

23. The image projection system of claim 1, further comprising:
light sensors configured to trigger the projecting of specific images.

24. The image projection system of claim 1, further comprising:
motion sensors configured to trigger the projecting of specific images.

25. The image projection system of claim 1, wherein the software further comprises:
an executive dashboard showing how many of the plurality of projectors are licensed, how many are active, and a summary of what each projector is currently displaying.

26. The image projection system of claim 1, wherein the software further comprises:
a projector edit settings screen showing network characteristics unique to a specific individual projector.

27. The image projection system of claim 1, wherein the software further comprises:
a scheduler menu for showing what will be displayed by an individual projector over a variety of time intervals selectable by a user.

28. The image projection system of claim 27, wherein the scheduler menu divides the projectors into separate groups of projectors.

29. The image projection system of claim 1, wherein the software further comprises:
an activity log screen showing the network activity of a specific projector.

30. The image projection system of claim 1, wherein the plurality of projectors display movable graphics by at least one of rotating, fading, and morphing.

31. The image projection system of claim 1, wherein the plurality of projectors are equipped to minimize the number of stop points in a particular image.

32. The image projection system of claim 1, wherein the plurality of projectors are equipped to create laser vectors from line art.

33. The image projection system of claim 1, wherein the software further comprises:
a function configured to put a box around all stop points belonging to a displayable item so that pressing the delete key will remove an entire image, rather than deleting vectors of the entire image one at a time.

34. A method of installing an image projection system, comprising:
installing at different in a facility a plurality of projectors;
connecting each of the projectors to a dedicated computer;
interconnecting each of the projectors within a computer network; and
configuring software present on the computer to control images displayed by the plurality of projectors.

35. A method of operating an image projection system, comprising:
installing at different locations in a facility a plurality of projectors;
connecting each of the projectors to a dedicated server in a computer network;
configuring software present on the dedicated server to control images displayed by the plurality of projectors; and
centrally coordinating all of said projectors through the network.

36. A program storage device readable by a machine, tangibly embodying a program of instructions executable by the machine to perform method steps for monitoring a physical activity, said method steps comprising:
establishing a presence of a plurality of projectors within a dedicated computer network;
verifying respective availability of the plurality of projectors;
dispatching respective images to be displayed on the plurality of projectors;
changing the images according to predetermined user timing criteria; and
managing the above steps by a dedicated server.
